(19) United States
(12) Patent Application Publication
(10) Pub. No.: US 2012/0007830 A1
(43) Pub. Date: Jan. 12, 2012

(54) TOUCH PANEL

(75) Inventors: Hsiao-Hui Liao, Taichung City (TW); Chih-Chang Lai, Taichung City (TW); Kun-Chang Ho, Taichung City (TW)

(73) Assignees: WINTEK CORPORATION, Taichung City (TW); DONGGUAN MASSTOP LIQUID CRYSTAL DISPLAY CO., LTD., Guangdong Province (CN)

(21) Appl. No.: 13/178,512

(22) Filed: Jul. 8, 2011

(30) Foreign Application Priority Data
Jul. 9, 2010 (TW) 99122682

(51) Int. Cl. G06F 3/041

(52) U.S. Cl. 345/174

(57) ABSTRACT

A touch panel having a touch sensing region and at least two connection regions around the touch sensing region is provided. The touch panel includes first conductive patterns, second conductive patterns, pads, and signal transmission lines. The first and second conductive patterns are disposed in the touch sensing region. Each first conductive pattern has a first end and an opposite second end. Each second conductive pattern has a third end and an opposite fourth end. The pads are respectively disposed in the connection regions. The first, second, third, and fourth ends are electrically connected to the pads in the corresponding connection region respectively through the signal transmission lines so that the distance from each first end, each second end, each third end, and each fourth end to the corresponding connection region is not greater than the distance from those to the other connection region.

### CROSS-REFERENCE TO RELATED APPLICATION

This application claims the priority benefit of Taiwan application serial no. 99122682, filed Jul. 9, 2010. The entirety of the above-mentioned patent application is hereby incorporated by reference herein and made a part of this specification.

### BACKGROUND OF THE INVENTION

1. Field of the Invention

The invention generally relates to a touch panel, and more particularly, to a touch panel having improved signal transmission quality.

2. Description of Related Art

Existing touch panels can be generally categorized into resistive touch panels, capacitive touch panels, infrared touch panels, and ultrasonic touch panels, wherein the resistive touch panels and the capacitive touch panels are presently the most popular products. The feature of multi-point touch control in a capacitive touch panel allows the capacitive touch panel to provide a more intuitional operation mode. Accordingly, the capacitive touch panel has been focused in the touch panel market. However, because the capacitive touch panel has to be operated by using a conductive material, a user cannot operate it with gloves on or by using a non-conductive material. Instead, a resistive touch panel can be operated by using any material. Thus, the resistive touch panel is more convenient to use. In addition, the resistive touch panel with lower manufacturing cost and more developed technique therefore takes a greater market share compared to other touch panels.

A large-scale electrode pattern is usually adopted as the sensing element in either a resistive touch panel or a capacitive touch panel, wherein the electrode pattern is composed of a plurality of sensor series that are crossed each other. Besides, the sensor series transmit signals to a plurality of pads disposed in a peripheral region of the touch panel through transmission lines, and the signals are outputted through a flexible printed circuit board, so that the coordinates of a touched point can be calculated. Since the transmission lines are all connected to the pads located within the same peripheral region from the two ends of the sensor series (i.e., a one-sided output design is adopted), transmission distances of the transmission lines are largely different. Namely, the maximum transmission impedance and the minimum transmission impedance of the signal transmission paths are distinct. Thus, in the conventional technique, the difference between the transmission impedances cannot be effectively reduced, and accordingly the signal transmission quality of the touch panel is not satisfactory. Besides, the impedance ratio between the touch sensing region and the transmission line region of the touch panel cannot provide 20:1 ratio to satisfy the chip specification. Thereby, a more developed touch panel technique needs to be provided.

### SUMMARY OF THE INVENTION

Accordingly, the invention is directed to a touch panel, wherein the transmission impedance difference of a plurality of signal transmission paths is reduced and the transmission quality of the touch signal is improved.

The invention provides a touch panel having a touch sensing region and at least two connection regions around the touch sensing region. The touch panel includes a plurality of first conductive patterns, a plurality of second conductive patterns, a plurality of pads, and a plurality of signal transmission lines. The first conductive patterns are disposed in the touch sensing region, wherein each of the first conductive patterns has a first end and an opposite second end. The second conductive patterns are disposed in the touch sensing region, wherein each of the second conductive patterns has a third end and an opposite fourth end, and the first conductive patterns and the second conductive patterns are substantially crossed each other. The pads are respectively disposed in the connection regions. The first ends, the second ends, the third ends, and the fourth ends are respectively electrically connected to the pads disposed in the corresponding connection region through the signal transmission lines so that the distance from each first end, each second end, each third end, and each fourth end to the corresponding connection region is not greater than the distance from the first end, the second end, the third end, and the fourth end to the other connection region.

As described above, in the invention, the distance from two opposite ends of each conductive pattern to a corresponding connection region is not greater than the distances from the two opposite ends of the conductive pattern to other connection regions. Thus, in the invention, the transmission distances of the signal transmission lines are not significantly varied. Thereby, the difference among transmission impedances of different signal transmission paths is effectively reduced and accordingly the signal transmission quality of the touch panel is improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a touch display device according to an embodiment of the invention.

FIG. 2A is a top view of a touch panel of the touch display device in FIG. 1.

FIG. 2B is a bottom view of the touch panel in FIG. 2A.

FIG. 3A is a top view of a touch panel according to another embodiment of the invention.

FIG. 3B is a bottom view of the touch panel in FIG. 3A.

FIG. 4A is a top view of a touch panel according to yet another embodiment of the invention.

FIG. 4B is a bottom view of the touch panel in FIG. 4A.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

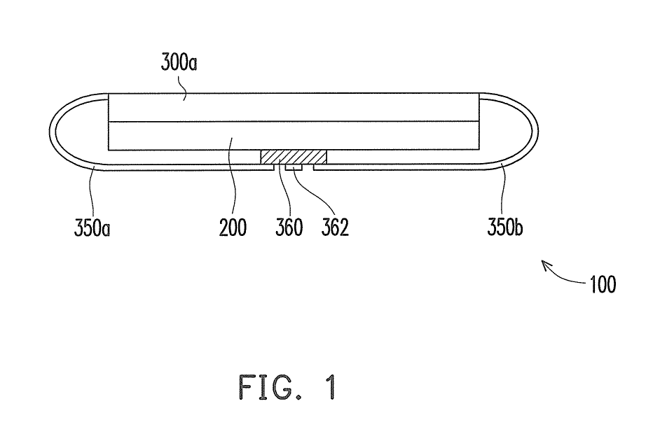

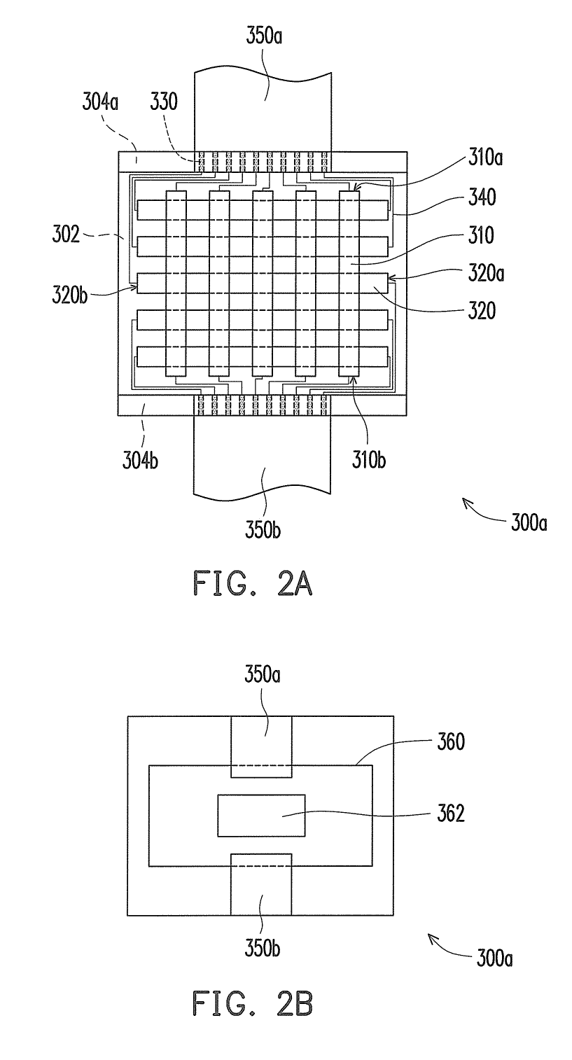

FIG. 1 is a diagram of a touch display device according to an embodiment of the invention. FIG. 2A is a top view of a touch panel of the touch display device in FIG. 1. FIG. 2B is a bottom view of the touch panel in FIG. 2A. Referring to FIG. 1, in the present embodiment, the touch display device 100 includes a display panel 200 and a touch panel 300a. The display panel 200 is disposed below the touch panel 300a, and can be a liquid crystal display (LCD) panel, an organic electro-luminescence display panel, a plasma display panel, an electronic paper panel, an electro wetting display panel, or other types of flat display panels. However, the invention is not limited thereto.

Referring to FIG. 2A, the touch panel 300a has a touch sensing region 302 and two connection regions 304a and 304b around the touch sensing region 302. The touch panel 300a is electrically connected to the display panel 200. The touch panel 300a includes a plurality of first conductive patterns 310, a plurality of second conductive patterns 320, a plurality of pads 330, and a plurality of signal transmission lines 340. The touch panel 300a may be a resistive touch panel, but the invention is not limited herein. The first conductive patterns 310 are disposed in the touch sensing region 302 and are electrically isolated from each other. Each first conductive pattern 310 has a first end 310a and a second end 310b opposite to the first end 310a. The second conductive patterns 320 are disposed in the touch sensing region 302 and are electrically insulated from each other. Each second conductive pattern 320 has a third end 320a and a fourth end 320b opposite to the third end 320a.

In the present embodiment, the first conductive patterns 310 and the second conductive patterns 320 may respectively be in a rectangular shape. The first conductive patterns 310 and the second conductive patterns 320 are substantially crossed each other. The first conductive patterns 310 and the second conductive patterns 320 may be perpendicular to each other or cross each other at an angle other than 90° or 0°. In the present embodiment, the first conductive patterns 310 and the second conductive patterns 320 are perpendicular to each other. However, the invention is not limited thereto. In addition, the first conductive patterns 310 and the second conductive patterns 320 are made of a transparent conductive material, such as indium tin oxide (ITO). Since the first conductive patterns 310 and the second conductive patterns 320 are all made of the transparent conductive material, the touch panel 300a in the present embodiment offers a high light transmittance.

The pads 330 are respectively disposed in the connection regions 304a and 304b. The first ends 310a and the second ends 310b of the first conductive patterns 310 and the third ends 320a and the fourth ends 320b of the second conductive patterns 320 are electrically connected to the pads 330 disposed in the corresponding connection region 304a (or connection region 304b) through the signal transmission lines 340. The distance from each first end 310a, each second end 310b, each third end 320a, and each fourth end 320b to the corresponding connection region 304a (or connection region 304b) is not greater than the distance from the first end 310a, the second end 310b, the third end 320a, and the fourth end 320b to the other connection region 304b (or connection region 304a). Namely, the first ends 310a and the second ends 310b of the first conductive patterns 310 and the third ends 320a and the fourth ends 320b of the second conductive patterns 320 are electrically connected to the pads 330 disposed in the connection region 304a or 304b through the corresponding signal transmission lines 340 in the relatively shorter transmission distance. In particular, the impedance ratio between the first conductive pattern 310 and the corresponding signal transmission lines 340 is larger than or equal to 20 and the impedance ratio between the second conductive pattern 320 and the corresponding signal transmission lines 340 is also larger than or equal to 20.

In the present embodiment, because the touch panel 300a adopts a two-sided output design, the first ends 310a and the second ends 310b of the first conductive patterns 310 and the third ends 320a and the fourth ends 320b of the second conductive patterns 320 are selectively electrically connected to the pads 330 disposed in the connection regions 304a and 304b through the signal transmission lines 340. Compared to the conventional one-sided output design, the difference between the transmission distances of the signal transmission lines 340 is not significant in the present embodiment. Namely, the difference between the longest transmission distance and the shortest transmission distance of the signal transmission lines 340 is far smaller than that of the transmission lines in the conventional technique. Thus, with the design of the touch panel 300a in the present embodiment, the difference between the transmission impedances of the signal transmission paths is effectively reduced and accordingly the signal transmission quality of the touch panel 300a is improved. Besides, the impedance ratio between the first conductive pattern 310 and the second conductive pattern 320 and the corresponding signal transmission lines 340 is greater than or equal to 20 to satisfy the chip specification that the ratio between the maximum transmission impedance and the minimum transmission impedance is 20, and accordingly the touch panel 300a meets the requirement of the touch panel market.

In addition, referring to FIG. 1 and FIG. 2B, the touch panel 300a further includes two flexible circuit boards 350a and 350b. The flexible circuit boards 350a and 350b are respectively disposed in the connection regions 304a and 304b, and electrically connected to the pads 330 in the corresponding connection region 304a (or connection region 304b). Moreover, the touch panel 300a further includes at least one main board 360 and at least one chip 362 disposed on the main board 360 (only one is illustrated in FIG. 1 and FIG. 2B), wherein the main board 360 is disposed under the touch panel 300a and the display panel 200. Thereby, the flexible circuit boards 350a and 350b are electrically connected to the chip 362 on the main board 360. Namely, the flexible circuit boards 350a and 350b are folded under the touch panel 300a, and the first conductive patterns 310 and the second conductive patterns 320 transmit signals to the chip 362 on the main board 360 through the flexible circuit boards 350a and 350b, so that the coordinates of a touched point can be calculated and output through a connector (not shown). The display panel 200 is located between the touch panel 300a and the main board 360 when the flexible circuit boards 350a and 350b are folded under the touch panel 300a.

Furthermore, the type of the touch panel 300a is not limited in the invention. Below, touch panels 300b-300c will be described with reference to different embodiments. It should be noted that the same reference numerals are used throughout the present disclosure for indicating the same elements and similar technical aspects that has been described in foregoing embodiments will be omitted in following embodiments.

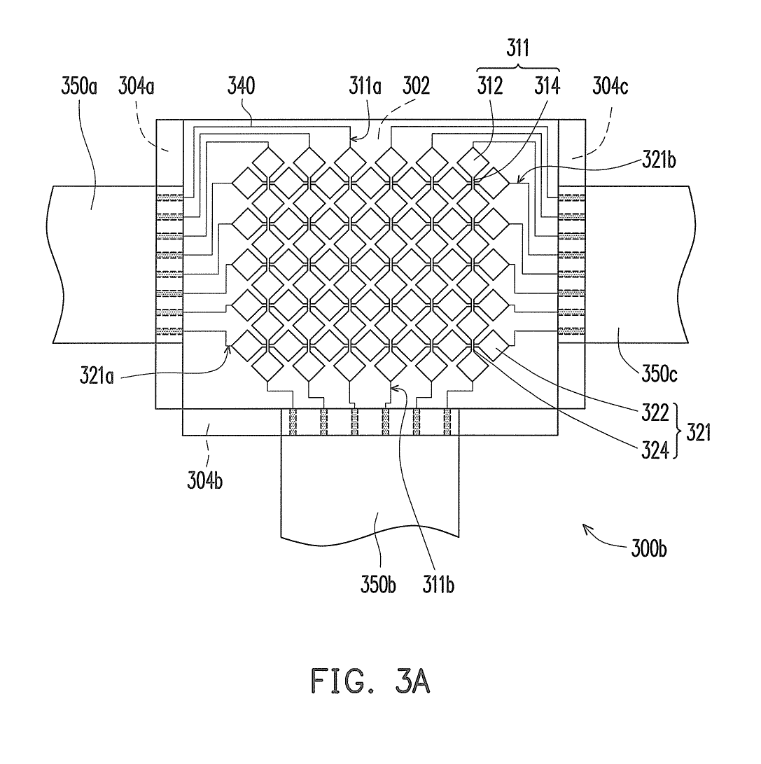

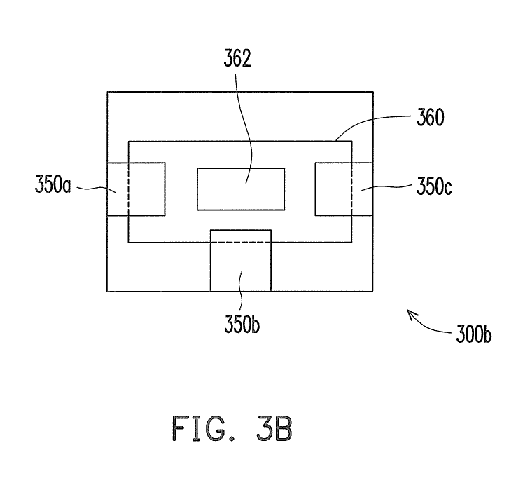

FIG. 3A is a top view of a touch panel according to another embodiment of the invention. FIG. 3B is a bottom view of the touch panel in FIG. 3A. Referring to both FIG. 1 and FIG. 3A, the touch panel 300b illustrated in FIG. 3A is similar to the touch panel 300a illustrated in FIG. 2A, and the difference between the two is that the touch panel 300b in FIG. 3A is a projected capacitive touch panel with three-sided output design and has three connection regions 304a, 304b, and 304c and three flexible circuit boards 350a, 350b, and 350c. The signals of the first conductive patterns 310 and the second conductive patterns 320 are transmitted to the chip 362 on the main board 360 through the three flexible circuit boards 350a, 350b, and 350c.

To be specific, each first conductive pattern 311 includes a plurality of first sensing pads 312 and a plurality of first bridging portions 314, wherein each first bridging portion 314 is electrically connected between two adjacent first sensing pads 312. Each second conductive pattern 321 includes a plurality of second sensing pads 322 and a plurality of second bridging portions 324, wherein each second bridging portion 324 is electrically connected between two adjacent second sensing pads 322, and each second bridging portion 324 crosses corresponding first bridging portion 314. Each second bridging portion 324 does not contact the one of the first bridging portions 314 and the first bridging portion 314 can be located above the second bridging portion 324. In other embodiments, the first bridging portion 314 can be optionally located under the second bridging portion 324. Furthermore, the first sensing pads 312 and the second sensing pads 322 can be disposed on the same plane or on different planes, which is not limited herein.

The first ends 311a and the second ends 311b of the first conductive patterns 311 and the third ends 321a and the fourth ends 321b of the second conductive patterns 321 are electrically connected to the pads 330 disposed in the corresponding connection region 304a (or connection region 304b or 304c) through the signal transmission lines 340 in a shortest distance. The distance from each first end 311a, each second end 311b, each third end 321a, and each fourth end 321b to the corresponding connection region 304a (or connection region 304b or 304c) is not greater than the distance from the first end 311a, the second end 311b, the third end 321a, and the fourth end 321b to the other connection region 304b (or connection region 304a or 304c). Accordingly, the impedance ratio between the first conductive pattern 311 and the corresponding signal transmission line 340 is greater than or equal to 20 and the impedance ratio between the second conductive pattern 321 and the corresponding signal transmission line 340 is greater than or equal to 20.

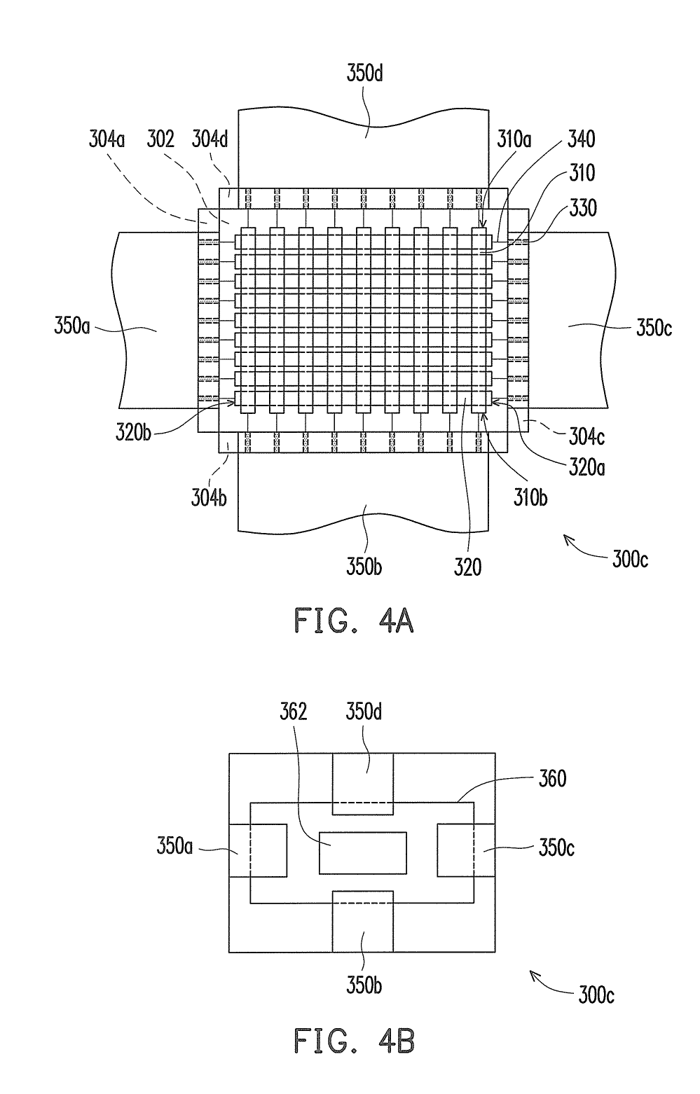

FIG. 4A is a top view of a touch panel according to another embodiment of the invention. FIG. 4B is a bottom view of the touch panel in FIG. 4A. Referring to both FIG. 2A and FIG. 4A, the touch panel 300c illustrated in FIG. 4A is similar to the touch panel 300a illustrated in FIG. 2A, and the difference between the two is that the touch panel 300c in FIG. 4A has a four-sided output design. The touch panel 300c has four connection regions 304a, 304b, 304c, and 304d, and the first conductive patterns 310 and the second conductive patterns 320 transmit signals to the chip 362 in the main board 360 through four flexible circuit boards 350a, 350b, 350c, and 350d.

As described above, in the invention, the distance that two opposite ends of each conductive pattern is connected to a corresponding connection region through the signal transmission lines is not greater than the distance that two opposite ends of each conductive pattern is connected to other connection region through the signal transmission lines. Namely, the transmission lines are used for connecting the ends of the conductive patterns to the pads disposed in adjacent connection regions. Thus, the difference between the transmission distances of different signal transmission lines is not significant, so that the difference between the transmission impedances is effectively reduced and the signal transmission quality of the touch panel is improved. Additionally, in the invention, the impedance ratio between the conductive pattern and the corresponding signal transmission line is greater than or equal to 20. Thus, the output impedance of the touch panel satisfies the chip specification that the ratio between the maximum transmission impedance and the minimum transmission impedance is 20. Thereby, the touch panel meets the requirement of the touch panel market.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch panel, having a touch sensing region and at least two connection regions around the touch sensing region, the touch panel comprising:
a plurality of first conductive patterns, disposed in the touch sensing region, wherein each of the first conductive patterns has a first end and a second end opposite to the first end;
a plurality of second conductive patterns, disposed in the touch sensing region, wherein each of the second conductive patterns has a third end and a fourth end opposite to the third end, and the first conductive patterns and the second conductive patterns are substantially crossed each other;
a plurality of pads, disposed in the connection regions; and
a plurality of signal transmission lines, electrically connecting the first ends, the second ends, the third ends, and the fourth ends respectively to the pads disposed in the corresponding connection region so that a distance from each of the first ends, each of the second ends, each of the third ends, or each of the fourth ends to the corresponding connection region is not greater than a distance from each of the first ends, each of the second ends, each of the third ends, or each of the fourth ends to the other connection region.

2. The touch panel according to claim 1 further comprising at least two flexible circuit boards, wherein the flexible circuit boards are respectively disposed in the connection regions, and each of the flexible circuit boards is electrically connected to the pads in the corresponding connection region.

3. The touch panel according to claim 2 further comprising a main board, wherein the main board faces away from the first conductive patterns and the second conductive patterns and is electrically connected to the flexible circuit boards.

4. The touch panel according to claim 1, wherein an impedance ratio between the touch sensing region and the signal transmission lines is greater than or equal to 20.

5. The touch panel according to claim 1, wherein each of the first conductive patterns comprises a plurality of first sensing pads and a plurality of first bridging portions, wherein each of the first bridging portions is electrically connected between adjacent two of the first sensing pads; each of the second conductive patterns comprises a plurality of second sensing pads and a plurality of second bridging portions, wherein each of the second bridging portions is electrically connected between adjacent two of the second sensing pads, and each of the second bridging portions crosses one of the first bridging portions.

6. The touch panel according to claim 1, wherein a material of the first conductive patterns and the second conductive patterns comprises indium tin oxide (ITO).

7. The touch panel according to claim 1, wherein a material of the signal transmission lines comprises a metal material.

8. The touch panel according to claim 1, wherein the signal transmission lines do not cross each other.
